(19) United States
(12) Patent Application Publication
(10) Pub. No.: US 2008/0184870 A1
(43) Pub. Date: Aug. 7, 2008

(54) SYSTEM, METHOD, DEVICE, AND COMPUTER PROGRAM PRODUCT PROVIDING FOR A MULTIPLE-LYRIC KARAOKE SYSTEM

(75) Inventor: Mika T. Toivola, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/552,479

(22) Filed: Oct. 24, 2006

(51) Int. Cl. G10H 1/36

(52) U.S. Cl. 84/610

(57) ABSTRACT

Systems, devices, methods, and computer program products are provided for facilitating a group karaoke performance. The system generally comprises at least two devices, each of the at least two devices includes a memory and a display, both operatively coupled to a processor. The memory of each device is configured to at least temporarily store karaoke data including a visual lyric data stream corresponding to one of a plurality of vocal parts in a song. The processor of each device is configured to present the visual lyric information on the display based on the visual lyric data stream stored in the memory. The at least two devices are synchronized so that they can start presenting the visual lyric information essentially at the same time. One of the devices displays visual lyric information for one vocal part of a song and another one of the devices displays visual lyric information for a different vocal part of a song.

### FIELD OF THE INVENTION

Embodiments of the invention generally relate to systems, devices, methods, and computer program products for facilitating a group karaoke performance. In particular, systems, methods, devices, and computer program products are provided in which two or more electronic devices are used to synchronously display different karaoke lyrics.

### BACKGROUND OF THE INVENTION

Karaoke is a form of entertainment where one or more persons, usually amateur singers, sing along to recorded music. Typically, a person sings along to a well-known song where at least some of the vocals have been removed or reduced in volume. A person may sing along without a microphone, although most karaoke systems have microphones and loudspeakers for amplifying the person's voice and playing the person's voice along with the song.

In addition to one or more microphones and loudspeakers, a conventional karaoke system also typically has a mixer for combining the voices of the singers with the karaoke song data, the output of which is sent to the loudspeakers for playback. Most karaoke systems also have a display that displays the lyrics of the karaoke song for the singer to follow during the karaoke performance. Often the lyrics change color in synchronization with the music in order to indicate to the singer the proper timing of the lyrics.

Karaoke has become popular throughout much of the world and karaoke systems can often be found in people's homes, in bars, and in night clubs. Sometimes a singer will sing by themselves while other times a group of singers may sing together. When a group of singers perform a karaoke song together, the people in the group must share microphones if the karaoke system is not equipped with enough microphones for the number of people in the group. Furthermore, the group is often forced to huddle around a single display in order to follow the lyrics to the song they are singing. While many karaoke systems can be configured to have multiple microphones and displays, the more microphones and displays that have to be maintained the more expensive the karaoke system is to own, operate, and maintain.

Another problem arises when a song has multiple vocal parts and each individual in a group of people wants to sing a particular one of these vocal parts. For example, a song may have a main vocal part and one or more back-up vocal parts, or a song may be a duet or have a chorus. Many conventional karaoke systems are designed for the singer to perform the main vocal part only. Such systems display lyrics for the main vocal part only. In systems that do provide lyrics for multiple vocal parts, the lyrics for one part are presented on each display together with lyrics for the other vocal parts. This is often a problem since having more than one vocal part on a single display can be confusing to the performer who is trying to follow the lyrics on the display for only one of the vocal parts. This is especially a problem when the vocal parts overlap each other.

The problems described above with conventional karaoke systems make it difficult to perform a particular vocal part of a song that contains multiple vocal parts. Furthermore, most karaoke systems are not well suited for group karaoke. These problems detract from the karaoke performance and the entertainment value to the singers, the audience, and everyone involved. Therefore, it would be advantageous to have a karaoke system that could better accommodate groups of singers performing multiple vocal parts of a karaoke song. It would also be desirable to have a karaoke system that was portable.

### BRIEF SUMMARY OF THE INVENTION

A system, method, device, and computer program product are therefore provided for facilitating a group karaoke performance. In particular, embodiments of the present invention provide two or more electronic devices that are configured to be used to synchronously display different karaoke lyrics.

Embodiments of the present invention provide a karaoke system including at least two devices. Each of the at least two devices includes a processor configured to present visual lyric information on a device display based on karaoke data. The at least two devices are synchronized so that corresponding visual lyric information is presented in synchronization. One device is configured to display visual lyric information that is different than the visual lyric information displayed by at least one other device.

At least one device in the karaoke system may be embodied as a mobile terminal, such as a mobile telephone. Each device in the karaoke system may comprise a transceiver operatively coupled to the processor and configured to communicate at least some karaoke data with other compatible devices, such as another of the at least two devices in the karaoke system. The processor of at least one device in the system may be configured to communicate timing information with at least another device to facilitate substantial synchronization of the lyrics presented on the display. At least one device in the karaoke system may have a microphone for capturing voice data, the processor of the device may be configured to communicate the captured voice data to at least one other compatible device and/or the processor of the at least one device may be configured to store the captured voice data in the memory of the at least one device. The karaoke system may include an external sound system having a speaker for playing karaoke data received from at least one device.

The karaoke system may have an external sound system including a memory device for storing karaoke data for a plurality of songs; a communication interface for communicating at least some of the karaoke data for a song, including at least one visual lyric data stream, to the at least two devices; and a speaker for playing the song while the visual lyric information is presented on the displays of the at least two devices. Such an external sound system may further include a microphone for capturing voice data of one of the users of the at least two devices, and a mixer for combining the captured voice data with the song prior to playing the song through the speaker. The external sound system may be configured to communicate audio song data to the at least two devices, wherein the at least two devices each comprise a speaker, wherein the processor of each device is configured to use the audio song data to play the song through the speaker including some, but not all, of the vocal parts of the song.

At least one device of the karaoke system may include a user input device configured to allow a user to select a visual lyric data stream from a plurality of visual lyric data streams available in the karaoke data for the song. The processor of the at least one device may be configured to use the selected visual lyric data stream to present the visual lyric information on the display of the at least one device. The karaoke data may include audio song data and each device in the karaoke system may include a speaker for playing at least a portion of the of the audio song data.

Embodiments of the present invention provide a computer program product for allowing an electronic device to coordinate a group karaoke performance. The computer program product includes at least one computer-readable storage medium having computer-readable program code portions stored therein. The computer-readable program code portions include a first executable portion for communicating with at least a first terminal and a second terminal and providing information to the terminals related to the plurality of visual lyric data streams available for the song. The computer-readable program code portions further include a second executable portion for receiving a selection of a first visual lyric data stream from the first terminal and a selection of a second different visual lyric data stream from the second terminal. The computer-readable program code portions also include a third executable portion for providing the first visual lyric data stream to the first terminal and for providing the second different visual lyric data stream to the second terminal such that a lyric display operation of the first and second terminals is thereafter capable of being synchronized.

The computer-readable program code portions may include an executable portion for processing voice data received from at least one of the first and second terminals, and a another executable portion for mixing the voice data with the song data and playing the mixed song and voice data through a speaker system of the electronic device. The computer program product may include an executable portion for providing timing information to the first and second terminals in order to synchronize the lyric display operation of the first and second terminals.

Embodiments of the present invention provide a method of performing group karaoke of a song having two or more different vocal parts. The method includes providing karaoke data to a first terminal with the karaoke data comprising a visual lyric data stream corresponding to a respective vocal part of the song to enable the first terminal to be capable of displaying corresponding lyrics; providing karaoke data to a second terminal with the karaoke data comprising a visual lyric data stream corresponding to a different vocal part of the song to enable the second terminal to be capable of displaying different corresponding lyrics; and permitting synchronization of the lyrics displayed by the first and second terminals.

The method may further include receiving voice data captured at the first and second terminals; mixing the captured voice data and the song; and playing the mixed song and voice data. The method may include prompting the users of the first and second terminals to select one visual lyric data stream from the plurality of visual lyric data streams; and receiving input from the first and second terminals to select a visual lyric data stream to be displayed by the respective terminals. The method may include playing the song at least one of the first and second terminals based upon song data; and synchronizing display of the lyrics with the playing of the song.

Embodiments of the present invention provide a device having a display and a processor operatively coupled to the display. The processor is configured to present visual lyric information on the display based on karaoke data comprising at least one visual lyric data stream relating to a respective vocal part of a song. The processor is also configured to either receive or transmit synchronization data to facilitate a presentation by the processor upon the display of visual lyric information in synchronization with a presentation of corresponding lyric information for a different vocal part of the song by another device.

The device may comprise a mobile terminal. The processor may be configured to either receive or transmit the synchronization data from or to the other device. The processor may be configured to either receive or transmit the synchronization from or to an external sound system. The processor may be configured to receive karaoke data from an external sound system. The device may also include a speaker and the processor may be further configured to play the song through the speaker based on karaoke data comprising song data.

Embodiments of the present invention provide a method including accessing karaoke data comprising at least one visual lyric data stream relating to a respective vocal part of a song; and presenting visual lyric information based on the karaoke data relating to the respective vocal part of a song. Presenting the visual lyric information may include either receiving or transmitting synchronization data to facilitate a presentation of the visual lyric information in synchronization with a presentation of corresponding lyric information for a different vocal part of the song by another device. Presenting the visual lyric information may include receiving or transmitting the synchronization data from or to the other device. Presenting the visual lyric information may include receiving or transmitting the synchronization data from or to an external sound system. Presenting visual lyric information may include presenting visual lyric information on a display of a mobile telephone. Accessing the karaoke data may include receiving karaoke data from an external sound system. The method may also include playing a version of the song based on karaoke data comprising song data.

Embodiments of the present invention provide a device having means for displaying information; and means for presenting visual lyric information on the means for displaying based on karaoke data comprising at least one visual lyric data stream relating to a respective vocal part of a song. The means for presenting includes means for either receiving or transmitting synchronization data to facilitate the display of visual lyric information in synchronization with a presentation of corresponding lyric information for a different vocal part of the song by another device. The device may further have means for providing audio; and means for playing a version of the song using the means for providing audio based on karaoke data comprising song data.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of an original song in accordance with one embodiment of the present invention;

FIG. 2 is a schematic block diagram of a karaoke song in accordance with one embodiment of the present invention;

FIG. 3 is a schematic block diagram of karaoke data in accordance with one embodiment of the present invention;

FIG. 4 is a schematic illustration of a karaoke system in accordance with one embodiment of the present invention;

FIG. 5 is a schematic block diagram of a mobile terminal in accordance with one embodiment of the present invention;

FIG. 6 is a schematic block diagram of one type of system that the mobile terminal may be configured to operate in, according to one embodiment of the present invention;

FIG. 7 is a schematic illustration of a karaoke system in accordance with another embodiment of the present invention;

FIG. 8 is a flowchart illustrating an exemplary process in which the two electronic devices of FIG. 7 may be used to perform group karaoke in accordance with one embodiment of the present invention; and

FIG. 9 is a schematic illustration of a karaoke system in accordance with yet another embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

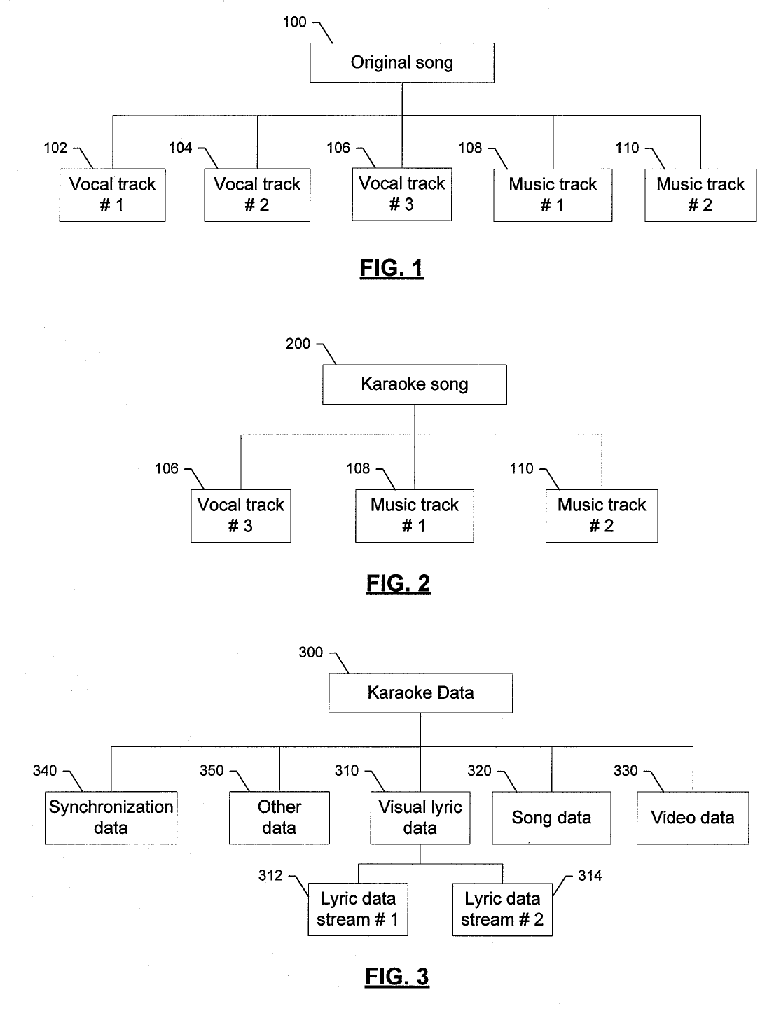

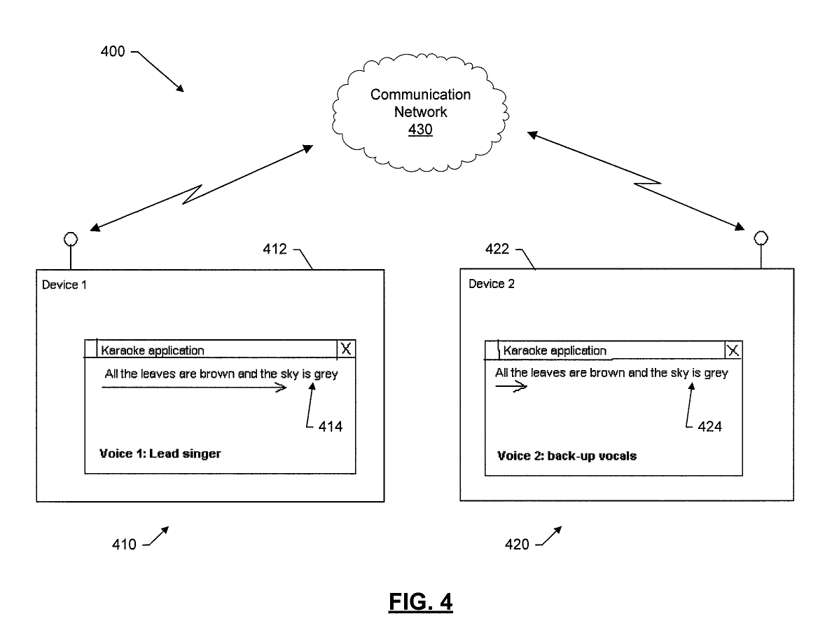

For purposes of the application and the claims, the term “song” is used to refer to a musical composition. The song may be comprised of one or more “vocal tracks” and one or more “music tracks.” A vocal track is the portion of the song generally containing at least one vocal portion of the song. A music track is the portion of the song generally containing an instrumental or accompaniment portion of the song. For purposes of this application, a song can be an “original song” or a “karaoke song.” As “original song” as used herein refers to a song in its original format, having all of the original vocal and music tracks. A “karaoke song” refers to a song where one or more of the vocal tracks have been removed or reduced in volume relative to the other vocal tracks and/or music tracks. For example, FIG. 1 provides an illustration of an exemplary original song 100 comprised of three vocal tracks 102, 104, and 106, and two music tracks 108 and 110. FIG. 2 provides an illustration on an exemplary karaoke version 200 of the original song 100. In the karaoke version 200 of the song 100, two of the vocal tracks 102 and 104 have been removed so that the karaoke song 200 includes only one vocal track 106 and the music tracks 108 and 110.

For purposes of this application, “karaoke data” refers to data that generally includes song data (e.g., data containing an original song and/or a karaoke song) and visual lyric data (i.e., data that can be used to provide a visual representation of the lyrics of one or more of the vocal tracks). The visual lyric data may comprise textual data, such as code information for displaying the lyric text in synchronization with progression of the song, or may comprise video data where the video, when displayed, contains images of the lyric text.

FIG. 3 is an exemplary illustration of the data that may make up karaoke data 300. As described above, the karaoke data 300 generally includes song data 320 and visual lyric data 310 relating to the lyrics of the song 320. The visual lyric data 320 may be comprised of one or more visual lyric data streams 312 and 314, each visual lyric data stream 312 and 314 containing visual lyric data related to the lyrics of a different vocal track of the song. The karaoke data 300 may also include video data 330 having video other than or in addition to video containing the lyrics. For example, the karaoke data may provide a video that is intended to play on the display behind the lyric text in sync with the song. The karaoke data 300 may also include data 340 related to the timing or synchronization of the lyric data, song data, and/or video data. For example the synchronization data may include one or more timestamps or time codes. The karaoke data 300 may contain other types of data, such as metadata about the song, such as the song title, artist and the like, and/or data about the file and/or other associated files.

The karaoke data may be presented in any data format and may be presented in a single file or multiple files. For example, typical file formats used in karaoke devices include MIDI, MIDI-Karaoke (i.e., .KAR), MIDI+TXK, CDG, MP3+G, WMA+G, CDG+MP3, OGG, MID, LRS, KOK, and LRC formats, or compressed versions of these formats. In one embodiment of the present invention, the karaoke system is designed to use file formats that are designed specifically to work only with the software, system, and/or device of the present invention. In some file formats, the song data and the lyric data are combined in the same file. In other file formats, the song data and the lyric data are contained in separate files, which may have different file formats. Some file formats integrate the lyric data and the song data so that they are automatically synchronized during playback. Other file formats, however, rely on the karaoke device to synchronize the lyric data with the song data. For example, some file formats include one or more timestamps, time codes, or other timing information that the karaoke device can use to synchronize the different data during playback.

Referring to FIG. 4, an illustration is provided of a karaoke system 400 according to one embodiment of the present invention. The karaoke system 400 is comprised of a first terminal 410 and second terminal 420. The first and second karaoke terminals 410 and 420 include first and second displays 412 and 422, respectfully. Although the karaoke system 400 is illustrated as comprising two karaoke terminals, the karaoke system 400 may comprise more than two karaoke terminals. The karaoke system 400 is configured such that the karaoke terminals 410 and 420 are synchronized so that they can start a karaoke performance essentially at the same time. The karaoke terminals 410 and 420 may be synchronized by communicating timing information with each other. The karaoke terminals 410 and 420 may be configured to communicate directly with each other, through a communication network 430, and/or through some other electronic device. In another embodiment, the karaoke terminals 410 and 420 may be synchronized by configuring the two terminals to communicate with another electronic device, the other electronic device configured to send timing information, codes, or signals to each terminal in order to manage the synchronization of the terminals.

The karaoke system 400 is configured so that, where a song has more than one vocal track, the karaoke system 400 can display the lyrics for at least two of the different vocal tracks on the different karaoke terminals 410 and 420. In other words, the karaoke system 400 is configured such that if the karaoke data 300 comprises a plurality of visual lyric data streams 312 and 314, the first karaoke terminal 410 can present on its display 412 visual representations of the lyrics 414 (e.g., the lyric text) based on one of the visual lyric data streams. The karaoke system 400 is further configured so that the second karaoke terminal 420 can present on its display 422 visual representations of lyrics 424 based on a visual lyric data stream different from the visual lyric data stream displayed on the first karaoke terminal 410. Typically, however, the karaoke terminals only display a visual representation of a single lyric and do not display visual representations of the other lyrics, thus resulting in visual representations of different lyrics being presented by the first and second karaoke terminals. In this way, one singer can view the display 412 of the first karaoke terminal 410 in order to sing one of the song's vocal tracks and another singer can view the display 422 of the second karaoke terminal 420 in order to sing a different one of the song's vocal tracks without either of the singers being confused or distracted by the display of lyrics other than those to be sung by the respective singer. Each terminal may further be configured to allow the user of the terminal to choose which visual lyric data stream will be presented on the terminal's display.

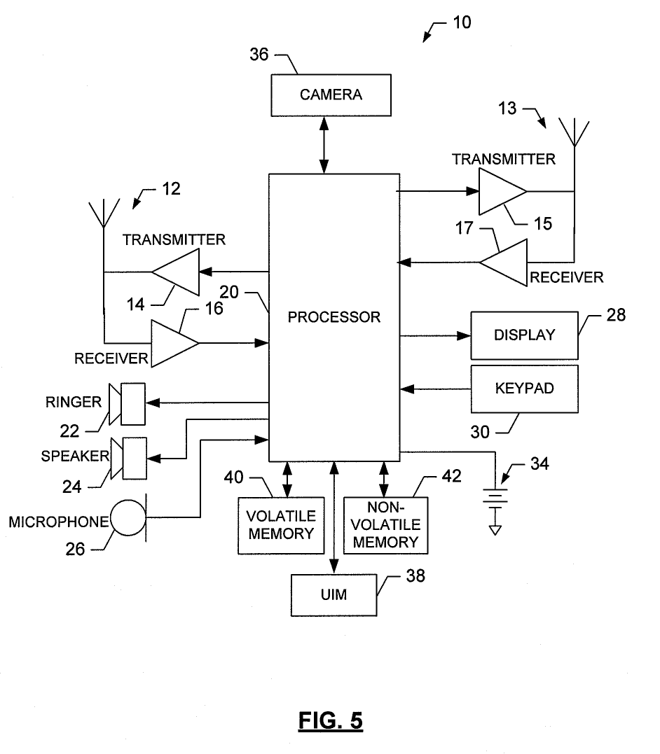

In one embodiment of the present invention, at least one of the karaoke terminals, if not all of the karaoke terminals, is embodied as a mobile terminal, such as a mobile telephone. FIG. 5 illustrates a block diagram of a mobile terminal 10 that may be used as one or more of the karaoke terminals 410 and 420 described above, according to one embodiment of the present invention. Although FIG. 5 and the other figures described below illustrate a mobile telephone as the mobile terminal, it should be understood that a mobile telephone is merely illustrative of one type of electronic device that could be used with embodiments of the present invention. While several embodiments of the mobile terminal 10 are illustrated and will be hereinafter described for purposes of example, other types of electronic devices, such as digital cameras, portable digital assistants (PDAs), pagers, mobile televisions, computers, laptop computers, mp3 players, satellite radio units, and other types of systems that manipulate and/or store data files and that comprise communication capabilities, can readily employ embodiments of the present invention. Such devices may or may not be mobile.

The mobile terminal 10 includes a communication interface comprising an antenna 12 in operable communication with a transmitter 14 and a receiver 16. The mobile terminal 10 further includes a processor 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

The communication interface of the mobile terminal 10 may also include a second antenna 13, a second transmitter 15, and a second receiver 17. The processor 20 also provides signals to and receives signals from the second transmitter 15 and second receiver 17, respectively. The second antenna 13, transmitter 15, and receiver 17 may be used to communicate directly with other electronic devices, such as other compatible mobile terminals. The mobile terminal 10 may be configured to use the second antenna 13, transmitter 15, and receiver 17 to communicate with other electronic devices in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like.

It is understood that the processor 20 includes circuitry required for implementing audio and logic functions of the mobile terminal 10 including those functions associated with multiple-lyric karaoke system. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 can additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera 36 in communication with the processor 20. The camera 36 may be any means for capturing an image for storage, display or transmission. For example, the camera 36 may include a digital camera capable of forming a digital image file from a captured image. As such, the camera 36 includes all hardware, such as a lens or other optical device, and software necessary for creating a digital image file from a captured image. Alternatively, the camera 36 may include only the hardware needed to view an image, while a memory device of the mobile terminal 10 stores instructions for execution by the processor 20 in the form of software necessary to create a digital image file from a captured image. In an exemplary embodiment, the camera 36 may further include a processing element such as a co-processor which assists the processor 20 in processing image data and an encoder and/or decoder for compressing and/or decompressing image data. The encoder and/or decoder may encode and/or decode according to a JPEG or an MPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

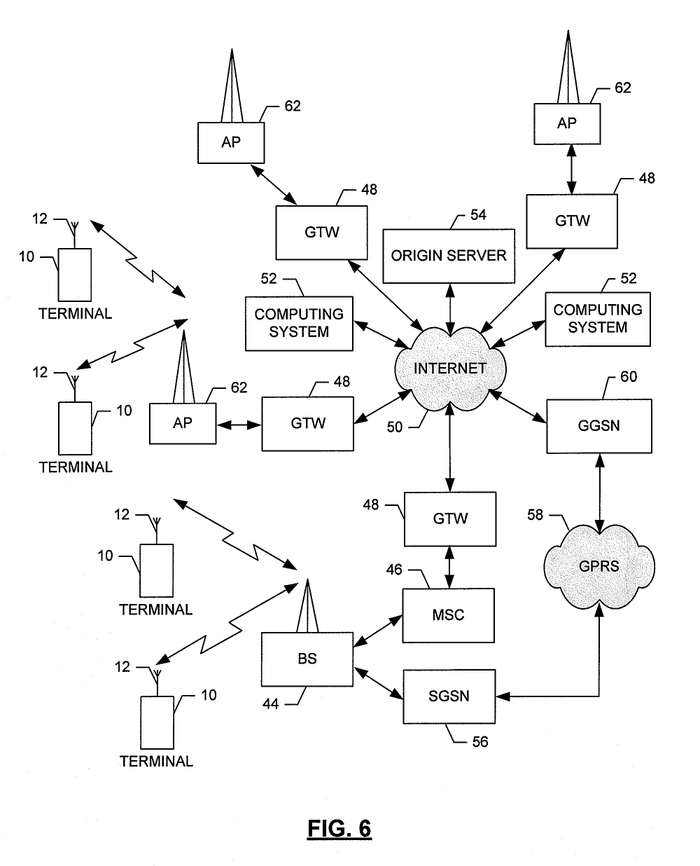

Referring now to FIG. 6, an illustration is provided of one type of system that the mobile terminal 10 may be configured to operate in, according to one embodiment of the present invention. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 5, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 5), origin server 54 (one shown in FIG. 5) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 6, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

Exemplary embodiments of the invention will now be described with reference to the mobile terminal and network of FIGS. 5 and 6. As described above, embodiments of the present invention are not necessarily limited to mobile terminals and can be used with any number of electronic devices or systems without departing from the spirit and scope of the present invention.

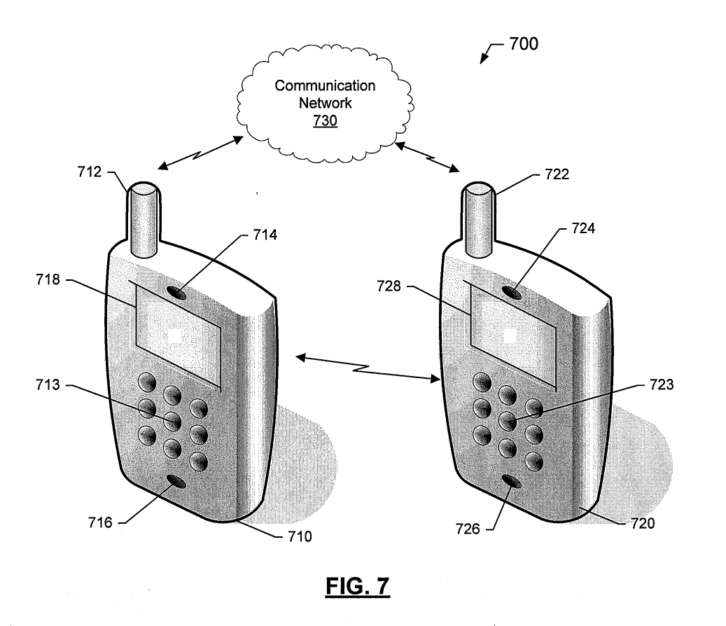

Referring to FIG. 7, an illustration is provided of a karaoke system 700 comprised of at least two karaoke terminals 710 and 720 embodied as mobile terminals in accordance with one embodiment of the present invention. More particularly, the karaoke system 700 is comprised of a first mobile terminal 710 and a second mobile terminal 720. The first and second mobile terminals 710 and 720 may be comprised of various embodiments of the mobile terminal 10 illustrated in FIG. 5 and may be configured to operate in embodiments of the system illustrated in FIG. 6.

In the embodiment described below, each mobile terminal 710 and 720 in the karaoke system 700 is configured to store and process karaoke data 300. Alternatively, the karaoke data may be provided by a network entity or by another mobile terminal and consumed in real time in the manner described below without the karaoke data being stored by the mobile terminal. In the embodiment in which the karaoke data is stored, however, the karaoke data 300 may be stored in the terminal's memory, or a portion of the terminal's memory accessible to the user. The karaoke data 300 may be downloaded to the terminal's memory from a wired or wireless connection with an external network, from a removable or an external memory device, or from another electronic device. For example, one or more of the terminals 710 and 720 may be configured to use the terminal's communication interface to wirelessly access a network, such as the Internet, to download the karaoke data 300 from another electronic device connected to the network.

In one embodiment of the present invention, the first terminal 710 is configured to use song data 320 from the downloaded karaoke data 300 in order to play a song through the speaker 714 of the first terminal 710 in synchronization with the song playing from the speaker 724 of the second terminal 720. The first terminal 710 is configured to display, on the display 718 of the first terminal 710, the lyrics to a first vocal track of the song in synchronization with the song being played through the speaker 714. The second terminal 720 is configured to display, on the display 728 of the second terminal 720, the lyrics to a second different vocal track of the song in synchronization with the song being played through the speaker 724. In this way, the users of terminals can sing along to the song together, the user of each terminal singing a different vocal part of the song and following the lyrics of his or her respective vocal part presented on his or her respective mobile terminal display. By typically limiting the display presented by each terminal to a single vocal track, or at least a subset of vocal tracks less than the total number of vocal tracks, the user of each terminal will have less opportunity to be confused by the presentation of multiple concurrent vocal tracks.

If the karaoke data comprises the original song, the users sing along with the original vocals. Preferably, however, the karaoke data comprises a karaoke song where the original vocal tracks are removed from the song or are reduced in volume relative to the volume of the music tracks.

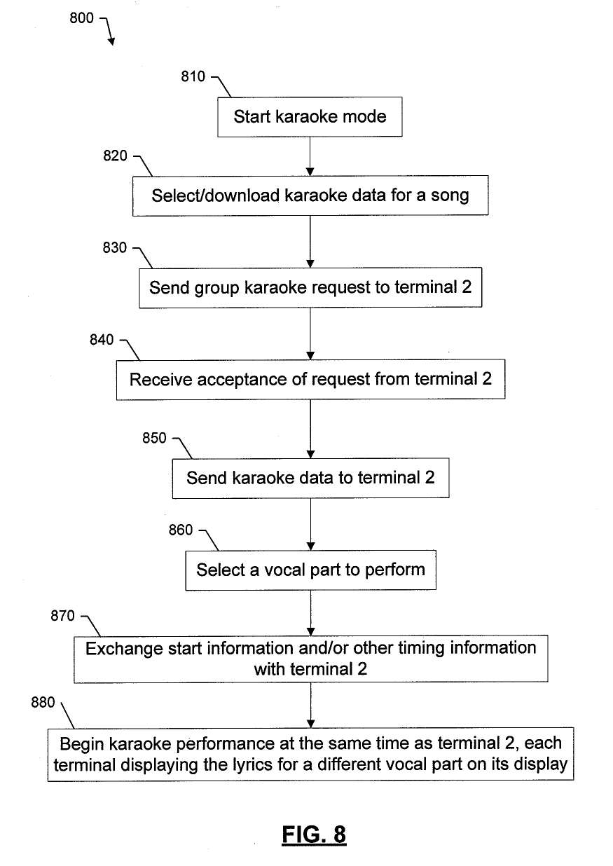

Referring to FIG. 8, an exemplary process 800 is illustrated in which an electronic device, such as mobile terminal 710, may engage in a group karaoke performance with another electronic device, such as mobile terminal 720, in accordance with one embodiment of the present invention. It should be appreciated that the process illustrated in FIG. 8 is exemplary of one embodiment of the present invention and other embodiments may comprise only some of the operations shown and/or may perform the operations in an order different from the order illustrated. As represented by block 810, the user of a first mobile terminal may actuate a user input device of the first terminal in order to select a karaoke mode from a menu or otherwise start a karaoke application stored in the first mobile terminal.

The first terminal's processor then begins execution of the karaoke application which interfaces with the display in order to prompt the user to select a song to use in a karaoke performance. As illustrated by block 820, the karaoke application may allow the user to select a song by either selecting karaoke data already stored in the first terminal or downloading karaoke data from an external network, a removable storage device, or another electronic device. For example, the application may be configured to use the communication interface of the first terminal to connect with the Internet. The application may then be configured to direct the user to a website of the user's choice or to some preprogrammed website that is known to offer karaoke data for downloading. If the user chooses to download karaoke data, the karaoke data may be downloaded and stored to a portion of the terminal's memory.

As illustrated by block 830, the user of the first terminal may send a group karaoke request to a second terminal using one of the terminal's communication interfaces. The two terminals may communicate using any one of the communication protocols discussed earlier with relating to FIGS. 5 and 6 so long as both terminals support the particular communication protocol. After the second terminal receives the first terminal's request for the second user's participation in a group karaoke performance and in instances in which the second terminal has been preloaded with the karaoke application, the processor of the second terminal executes the karaoke application which solicits the second user's interest in the group karaoke performance. In other instances in which the second terminal has not been preloaded with the karaoke application, the karaoke application may be provided with the request by the first terminal or the second terminal may otherwise first download the karaoke application in response to the request by the first terminal prior to soliciting the second user's interest. The second user may respond by operating a user input device on the second terminal in order to indicate an answer to the request (block 840). As described above, although FIG. 8 illustrates that a song is first selected by the first terminal and then the first terminal sends a group karaoke request to a second terminal, in other embodiments the first terminal first sends the group karaoke request to the second terminal and then either the first or second terminal selects a song.

Referring again to FIG. 8, upon acceptance of the request and selection of a song, the second terminal may download the karaoke data corresponding to the selected song from the first terminal if such karaoke data is not already stored on the second terminal (block 850). If the karaoke data includes multiple vocal data streams corresponding to multiple vocal tracks, each terminal may be configured to prompt the user to select one of the vocal data streams to be presented on the terminal's display. Once the user of each terminal actuates a user input device of the terminal to select a vocal data stream corresponding to the vocal part of the song that the user desires to sing (block 860), the terminals may exchange timing information (block 870) and simultaneously begin the karaoke performance (block 880). More particularly, each terminal may use the song data to begin to play the song through the terminal's speaker and may use the selected visual lyric data stream to display the lyrics on the display. Each terminal may use synchronization data, such as time codes (e.g., MIDI time codes, SMPTE time codes, and the like), included in the karaoke date to synchronize playback of the audio and video data. The terminals may also exchange timing information (continuously or at predefined intervals) via their communication interfaces in order to ensure that each terminal is presenting the karaoke data at the same time and at the same rate as the other terminal.

For example, one terminal of the group of terminals may be designated as the main timing terminal and may synchronize the presenting of karaoke data in the other terminals by sending timing information to the other terminals. The timing information may include start, stop, and continue signals. For example, a start signal may indicate to the other terminals to start presenting the song or other data from the beginning of the song or data (or from some other designated starting point). A stop signal may indicate to the other terminals to stop presenting the data. A continue signal may indicate to the other terminals to continue to present the data from the point at which it was last stopped. The main timing terminal may also repeatedly emit time codes to the other terminals and the other terminals may use the time codes to synchronize an internal clock with the main timing terminal's internal clock. The time codes received by the other terminals from the main timing terminal may have priority over other time codes received by or generated in the terminals. The time codes may be based on real time, relative time, or both. The “clocks” in each terminal may be actual clocks or may simply be incremental or decremental counters.

In one embodiment of the present invention, no single terminal is used to send time codes to the other terminals and instead the clocks of each terminal are synchronized by receiving time codes from an external source, such as a cellular tower or radio transmitter that receives a signal from an atomic clock or other source. If all of the terminals in the group are receiving the time codes from the same external source or from synchronized external sources, then the group of terminals will also be substantially synchronized.

In one embodiment, the timing information comprises song position pointer (SPP) messages that keep track of how much of the song has elapsed. For example, in an embodiment of the present invention where the song data comprises MIDI data, the main terminal may periodically issue SPP messages that keep track of, for example, how many 16^{th} notes have elapsed since the beginning of a song. The other terminals in the group may then adjust the playback of the song in order to substantially synchronize their playback with the information received from the main terminal relating to how much of the song has elapsed.

Using embodiments of the present invention, the users of the two terminals can participate in karaoke together. For example, if the first user of the first terminal chose to sing the lead vocal part of a song and the second user of the second terminal chose to sing the backup vocals for the song, the lyrics for the lead vocal part are displayed across the display of the first terminal and the lyrics for the backup vocal part are displayed across the display of the second terminal. The lyrics may be displayed in synchronization with the music and the lyrics may change color or the display may show a bouncing ball or provide some other indication as to when each word or syllable should be sung in order to be in time with the accompanying music playing from the speaker.

In one embodiment of the present invention, the song played through the speaker of the terminal does not contain any vocal tracks. In another embodiment, the song played through the speaker of the terminal contains all of the vocal tracks other than the vocal track being sung by the user of that terminal. In another embodiment, the song played through the speaker of the terminal contains all of the vocal tracks other than the vocal tracks being sung by anyone in the group. In other words, in one embodiment of the present invention, the terminal and/or the application are configured so that some vocal tracks can be removed or reduced in volume while other vocal tracks can be played.

In the exemplary embodiment of the karaoke system 700 described above, each user can hear the music through the terminal's speakers and follow the lyrics that the user is supposed to sing on the terminal's display. In such an embodiment, where the users do not use microphones to amplify or transmit their voices, the users would likely get the most enjoyment from the karaoke system 700 if the users are in the same general area so that they can hear each other as they perform the karaoke song together.

In another embodiment of the present invention, the microphone of each mobile terminal may be used during the karaoke performance to capture the voice of the user of the mobile terminal. In one exemplary embodiment, the microphone of the mobile terminal captures the user's voice during the karaoke performance and the terminal processes and amplifies the user's voice, mixing the user's voice with the song and playing it through the terminal's speaker. In one embodiment, the user's voice is captured by the first terminal's microphone and is sent, via the first terminal's communication interface, to a second terminal in the group where the user's voice is mixed with the song and played through the second terminal's speaker as the second user sings along. In one embodiment, the second singer's voice is captured by the second terminal's microphone and mixed with the first user's voice and the song for playback. Using the microphone of one terminal to capture the one user's voice and sending it to the other terminal for playback as the other terminal's user sings along may be particularly useful where the two karaoke participants are located apart from each other.

In another embodiment, one or more of the mobile terminals in the group are terminals for users who do not want to participate in singing a vocal part but who want to listen to the performance as audience members. For users who select to participate in the karaoke performance as audience members, their terminals may be configured only to receive communications from the other terminals including the song and the various singers' voices for playback through the audience terminal's speaker. In one embodiment, an audience terminal receives the data so that the singing data and the song data are already mixed. In another embodiment, the audience terminal must mix the song and voice data in order to play the karaoke performance through the audience terminal's speaker. Audience terminals may be particularly useful for people to listen to a karaoke performance when these people are not located near the performers.

In one embodiment, the user's voice during the karaoke performance is captured by the terminal's microphone and recorded to the terminal's memory. The user's voice may be mixed with the song data and then recorded or the voice data may be first recorded and then mixed with the song data. For example, the voice data may be initially recorded as a wave file and then mixed with the song data and saved as an mp3 file. In one embodiment, each terminal receives voice data from one of the other terminals participating in the karaoke performance and records this data. In such an embodiment, the receiving terminal may receive timing information, such as timing codes, from the other terminal along with the voice data so that the receiving terminal may accurately mix the received voice data with the song data and other voice data prior to playback. In some embodiments, the terminal may be configured to perform various operations on the voice data that is captured by the terminal's microphone is order to change various auditory properties of the voice data during playback.

In some embodiments, a user of one of the mobile terminals may use a headset comprising a microphone and/or a speaker as the terminal's microphone and/or speaker. The headset communicates with the terminal via one of the terminal's communication interfaces and may be wired or wireless. The user's headset may send/receive audio data to/from the user's terminal. In one embodiment, the user's headset may also send/receive data directly to/from another compatible terminal participating in the karaoke performance, thereby bypassing the terminal's communication interface.

In one embodiment, one or more of the terminals are configured to play video data from the karaoke data on the terminal's display in addition to the lyrics. In one embodiment, one or more of the terminals have cameras capable of capturing images or video that the user can use to video themselves or another subject while they sing. The video data captured during the karaoke performance can be recorded with song data and the voice data in the user's terminal in order to make a music video. In one embodiment, the terminal having a camera is configured so that it can send the image data to other terminals to be displayed on the other terminals' displays during the karaoke performance.

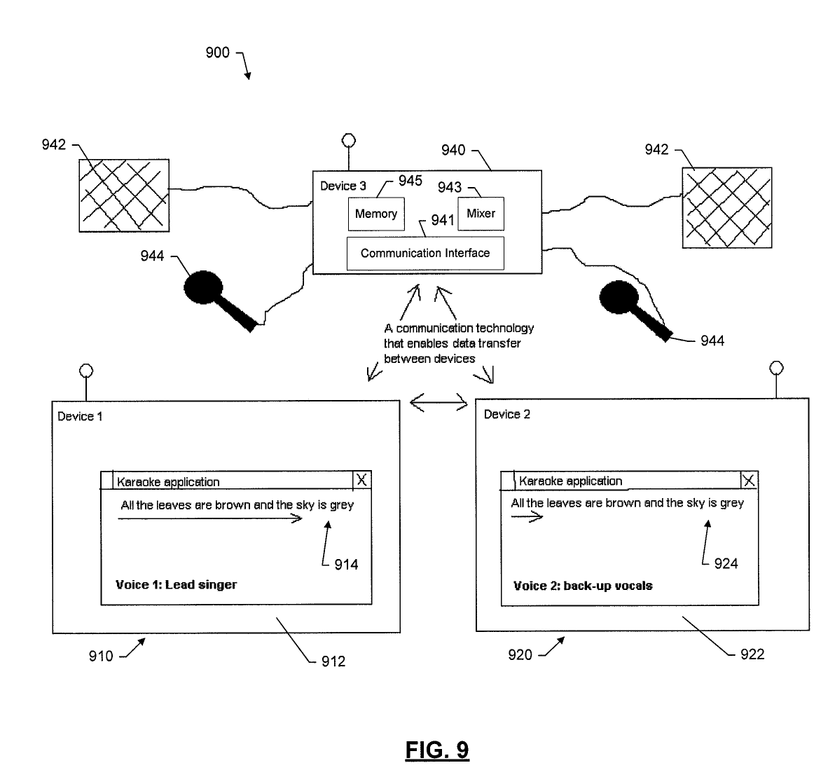

Referring to FIG. 9, another exemplary karaoke system in accordance with embodiments of the present invention is illustrated. In the illustrated embodiment, the karaoke system 900 comprises at least two karaoke terminals, which may be embodied as mobile terminals 910 and 920, and a specialized sound system 940. The first and second mobile terminals 910 and 920 may be comprised of various embodiments of the mobile terminal 10 illustrated in FIG. 5 and may be configured to operate in embodiments of the system illustrated in FIG. 6. The specialized sound system 940 generally comprises one or more speakers 942 and one or more microphones 944 and 946. In one embodiment of the karaoke system 900, the sound system 940 is configured to communicate with the mobile terminals 910 and 920 via one or more communication interfaces that are compatible with one of the communication interfaces of each mobile terminal 910 and 920. The sound system 940 is configured to communicate visual lyric data to the mobile terminals 910 and 920 so that the terminals may present lyrics 914 and 924 on their respective displays 912 and 922.

For example, in one embodiment of the karaoke system 900, mobile terminals 910 and 920 are configured to communicate with the sound system 940 in order to establish communication with the sound system 940 and to indicate a user's willingness to use the mobile terminal to participate in a karaoke performance. Once communication is established between the sound system 940 and the mobile terminals 910 and 920, a user of one of the mobile terminals may be able to use his or her mobile terminal 910 to select a song for the karaoke performance. If the karaoke performance is to be a group performance, the mobile terminal 910 may be used to select one or more other users to participate in the karaoke performance. For example, another user may also have a compatible mobile terminal 920 that he or she chooses to use for the karaoke performance.

If a song is selected that has more than one vocal track, the sound system 940 may communicate a list of the vocal tracks available to the mobile terminals 910 and 920. The users of the mobile terminals 910 and 920 may then each operate a user input device of the mobile terminal in order to communicate a selected vocal track to the sound system 940. For example, the user of a first mobile terminal 910 may select to perform the lead singer's vocal part and the user of a second mobile terminal 920 may select to perform the back-up vocals.

Once the vocal tracks have been selected, the sound system 940 may communicate the appropriate visual lyric data stream to each terminal based on the selected vocal track. The sound system 940 may then begin the karaoke performance by starting to play the karaoke song through the speakers 942 and communicating a starting signal and/or other timing information to the mobile terminals 910 and 920 indicating that the terminals may begin displaying the lyrics 914 and 924. The users then view the displays 912 and 922 of their mobile terminals 910 and 920 in order to follow the lyrics for their particular vocal part.

As the users follow the displayed lyrics, the users sing into microphones 944 and 946. The sound system 940 receives the voice data for each user from the microphones 944 and 946, amplifies and processes the voice data, and mixes the voice data with the song data and plays the mixed data through the speakers 942. The mobile terminals may periodically communicate timing information with the sound system 940 and/or with each other to ensure that the operation of displaying the lyrics is synchronized with each other and generally with the playback of the song. In this way, embodiments of the present invention illustrated in FIG. 9 may be permit a karaoke venue to have a sound system 940 that allows anyone in the venue who has a compatible mobile terminal, such as a mobile telephone or PDA device, to use their mobile terminal during a karaoke performance to display the lyrics for a particular vocal track of a song. In one embodiment, the sound system is configured to be compatible with a variety of mobile terminals while in other embodiments, the mobile terminal must include special karaoke-enabling software in order to be compatible with the sound system and/or with other mobile terminals.

In another embodiment of the karaoke system 900, a microphone and/or a speaker of each mobile terminal may be used as the microphones and speakers of the sound system 940. In other words, the microphones of the mobile terminals 910 and 920 may be used to capture the voice data of a user during the karaoke performance and communicate the voice data to the sound system 940 for mixing, processing, and playback. In one embodiment, a microphone or a speaker of a mobile terminal 910 may be embodied as a wired or wireless headset configured to communicate with the mobile terminal.

In one embodiment, in addition to communicating visual lyric data, the sound system 940 also communicates song data to the mobile terminals. The song data may comprise a version of the song without the vocal tracks removed. In such a case, the mobile terminal 910 may then be configured to play this version of the song through its speakers or through the headset speakers at the same time that the sound system 940 plays a karaoke version of the song (i.e., a version where the vocal tracks are removed). Such a system would allow the performer to not only follow the lyrics for his or her respective vocal part on the display of his or her mobile terminal 910, but also allow the user to sing along with the audio of the original singer's vocal part. If the user was using a headset, only the user would be able to hear the original vocals and the rest of the audience would only hear the user's voice mixed with the accompaniment music, which would be played through the sound system 940.

In another embodiment of the karaoke system 900, a central karaoke communication system, such as a satellite system, is configured to communicate karaoke data to both the sound system 940 and to the mobile terminals 910 and 920, simultaneously, in a continuous data stream. The sound system 940 may use the karaoke data to play the song data through the speakers 942 and the mobile terminals 910 and 920 may be configured to use the streaming karaoke data to display the lyrics 914 and 924 for a selected vocal part on the terminal's display 912 and 914. In this way, the mobile terminals 910 and 920 and the sound system 940 would be automatically generally in time with each other in much the same way as two FM radios would be substantially in synch if tuned to the same frequency.

In another embodiment of the karaoke system 900, the two or more mobile terminals 910 and 920 are configured as described above with respect to FIG. 7 and are configured to communicate karaoke data between each other. At least one of the terminals, however, is configured to use its processor to mix the song data with voice data of all of the users in the group and has a transceiver for sending the mixed data to an external sound system 940. For example, in such an embodiment, the sound system 940 may simply be an FM radio-equipped stereo system and the mobile terminal's transceiver may be an FM modulator. The FM modulator may be configured to communicate the song data or the mixed data to the stereo system at a particular FM frequency so that the stereo can be used to play the song or the karaoke performance through its speaker system.

The above described functions may be carried out in many ways. For example, any suitable means for carrying out each of the functions described above may be employed to carry out embodiments of the invention. According to one aspect of the present invention, all or a portion of the system of the present invention generally operates under control of a computer program product. The computer program product for performing the various processes and operations of embodiments of the present invention includes a computer-readable storage medium, such as a non-volatile storage medium, and computer-readable program code portions, such as a series of computer instructions, embodied in the computer-readable storage medium. For example, the respective processors of the first and second terminals (as well as a sound system or other network entity in some embodiments) generally execute a karaoke application in order to perform the various functions described above by reference more generally to the first and second terminals.

In this regard, FIGS. 8 and 9 are schematic illustrations, flowcharts, or block diagrams of methods, systems, devices, and computer program products according to embodiments of the present invention. It will be understood that each block of a flowchart or each step of a described method can be implemented by computer program instructions. These computer program instructions may be loaded onto a computer or other programmable apparatus to produce a machine, such that the instructions which execute on the computer or other programmable apparatus create means for implementing the functions specified in the described block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the described block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the described block(s) or step(s).

It will also be understood that each block or step of a described herein, and combinations of blocks or steps, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A karaoke system comprising:
at least two devices, each of the at least two devices comprising:
a processor; and
a display operatively coupled to the processor, the processor configured to present visual lyric information on the display based on karaoke data comprising at least one visual lyric data stream relating to a respective vocal part of a song;
wherein the at least two devices are synchronized so that corresponding visual lyric information is presented in synchronization, and
wherein at least one device is configured to display visual lyric information that is different than the visual lyric information displayed by at least one other device.

2. The karaoke system of claim 1, wherein at least one device is embodied as a mobile terminal.

3. The karaoke system of claim 2, wherein at least one device is embodied as a mobile telephone.

4. The karaoke system of claim 1, wherein each device comprises a transceiver operatively coupled to the processor and configured to communicate at least some karaoke data with other compatible devices.

5. The karaoke system of claim 4, wherein at least one device is configured to share karaoke data with at least one other device.

6. The karaoke system of claim 5, wherein the processor of at least one device is configured to communicate timing information with at least another device to facilitate substantial synchronization of the lyrics presented on the display.

7. The karaoke system of claim 4, wherein at least one device comprises a microphone for capturing voice data, and wherein the processor of the at least one device is configured to communicate the captured voice data to at least one other compatible device.

8. The karaoke system of claim 4, further comprising an external sound system comprising a speaker for playing karaoke data received from at least one device.

9. The karaoke system of claim 4, further comprising an external sound system comprising:
a memory device for storing karaoke data for a plurality of songs;
a communication interface for communicating at least some of the karaoke data for a song, including at least one visual lyric data stream, to the at least two devices; and
a speaker for playing the song while the visual lyric information is presented on the displays of the at least two devices.

10. The karaoke system of claim 9, where the external sound system further comprises:
at least one microphone for capturing voice data of at least one of the users of the at least two devices; and
a mixer for combining the captured voice data with the song prior to playing the song through the speaker.

11. The karaoke system of claim 9, wherein the external sound system is configured to communicate audio song data to the at least two devices, wherein the at least two devices each comprise a speaker, wherein the processor of each device is configured to use the audio song data to play the song through the speaker including some, but not all, of the vocal parts of the song.

12. The karaoke system of claim 1, wherein at least one device comprises a user input device configured to allow a user to select a visual lyric data stream from a plurality of visual lyric data streams available in the karaoke data for the song, and wherein the processor of the at least one device is configured to use the selected visual lyric data stream to present the visual lyric information on the display of the at least one device.

13. The karaoke system of claim 1, wherein the karaoke data further comprises audio song data, and wherein each device comprises:
a speaker for playing at least a portion of the of the audio song data.

14. The karaoke system of claim 1, wherein at least one device comprises a microphone for capturing voice data, and wherein the processor of the at least one device is configured to store the captured voice data in the memory of the at least one device.

15. A computer program product for allowing an electronic device to coordinate a group karaoke performance, the computer program product comprising at least one computer-readable storage medium having computer-readable program code portions stored therein, the computer-readable program code portions comprising:
a first executable portion for communicating with at least a first terminal and a second terminal and providing information to the terminals related to the plurality of visual lyric data streams available for the song;
a second executable portion for receiving a selection of a first visual lyric data stream from the first terminal and a selection of a second different visual lyric data stream from the second terminal; and
a third executable portion for providing the first visual lyric data stream to the first terminal and for providing the second different visual lyric data stream to the second terminal such that a lyric display operation of the first and second terminals is thereafter capable of being synchronized.

16. The computer program product of claim 15, further comprising:
a fourth executable portion for processing voice data received from at least one of the first and second terminals; and
a fifth executable portion for mixing the voice data with the song data and playing the mixed song and voice data through a speaker system of the electronic device.

17. The computer program product of claim 15, further comprising a fourth executable portion for providing timing information to the first and second terminals in order to synchronize the lyric display operation of the first and second terminals.

18. A method of performing group karaoke of a song having two or more different vocal parts, the method comprising:
providing karaoke data to a first terminal with the karaoke data comprising a visual lyric data stream corresponding to a respective vocal part of the song to enable the first terminal to be capable of displaying corresponding lyrics;
providing karaoke data to a second terminal with the karaoke data comprising a visual lyric data stream corresponding to a different vocal part of the song to enable the second terminal to be capable of displaying different corresponding lyrics; and
permitting synchronization of the lyrics displayed by the first and second terminals.

19. The method of claim 18 further comprising:
receiving voice data captured at the first and second terminals;
mixing the captured voice data and the song; and
playing the mixed song and voice data.

20. The method of claim 18 further comprising:
prompting the users of the first and second terminals to select one visual lyric data stream from the plurality of visual lyric data streams; and
receiving input from the first and second terminals to select a visual lyric data stream to be displayed by the respective terminals.

21. The method of claim 18, further comprising:
playing the song at least one of the first and second terminals based upon song data; and
synchronizing display of the lyrics with the playing of the song.

22. A device comprising:
a display; and
a processor operatively coupled to the display, the processor configured to present visual lyric information on the display based on karaoke data comprising at least one visual lyric data stream relating to a respective vocal part of a song, wherein the processor is also configured to either receive or transmit synchronization data to facilitate a presentation by the processor upon the display of visual lyric information in synchronization with a presentation of corresponding lyric information for a different vocal part of the song by another device.

23. The device of claim 22, wherein the device comprises a mobile terminal.

24. The device of claim 22, wherein the processor is configured to either receive or transmit the synchronization data from or to the other device.

25. The device of claim 22, wherein the processor is configured to either receive or transmit the synchronization from or to an external sound system.

26. The device of claim 22, wherein the processor is further configured to receive karaoke data from an external sound system.

27. The device of claim 22, further comprising:
a speaker, wherein the processor is further configured to play the song through the speaker based on karaoke data comprising song data.

28. A method comprising:
accessing karaoke data comprising at least one visual lyric data stream relating to a respective vocal part of a song; and
presenting visual lyric information based on the karaoke data relating to the respective vocal part of a song, wherein presenting the visual lyric information comprises either receiving or transmitting synchronization data to facilitate a presentation of the visual lyric information in synchronization with a presentation of corresponding lyric information for a different vocal part of the song by another device.

29. The method of claim 28, wherein presenting the visual lyric information comprises receiving or transmitting the synchronization data from or to the other device.

30. The method of claim 28, wherein presenting the visual lyric information comprises receiving or transmitting the synchronization data from or to an external sound system.

31. The method of claim 28, wherein accessing karaoke data comprises receiving karaoke data from an external sound system.

32. The method of claim 28, further comprising:
playing a version of the song based on karaoke data comprising song data.

33. The method of claim 28, wherein the presenting visual lyric information comprises presenting visual lyric information on a display of a mobile telephone.

34. A device comprising:
means for displaying information; and
means for presenting visual lyric information on the means for displaying based on karaoke data comprising at least one visual lyric data stream relating to a respective vocal part of a song, wherein the means for presenting comprises means for either receiving or transmitting synchronization data to facilitate the display of visual lyric information in synchronization with a presentation of corresponding lyric information for a different vocal part of the song by another device.

35. The device of claim 34 further comprising:
means for providing audio; and
means for playing a version of the song using the means for providing audio based on karaoke data comprising song data.
